(19) United States
(12) Patent Application Publication
(10) Pub. No.: US 2016/0107861 A1
(43) Pub. Date: Apr. 21, 2016

(54) CLOUD SERVER BASED CONTROL

(71) Applicant: OTIS ELEVATOR COMPANY, Farmington, CT (US)

(72) Inventors: Ronnie E. Thebeau, Haddam, CT (US); Vincent Della Valle, Greenwich, CT (US); Daryl J. Marvin, Farmington, CT (US); Jeremy Youker, West Hartford, CT (US); Helmut Lothar Schroeder-Brumloop, Berlin (DE)

(21) Appl. No.: 14/895,589

(22) PCT Filed: Jun. 11, 2013
(86) PCT No.: PCT/US2013/045071

§ 371 Date: Dec. 3, 2015

(51) Int. Cl. B66B 5/00; B66B 25/00; H04L 29/08; B66B 1/34

(52) U.S. Cl. CPC B66B 5/0025; B66B 1/3461; B66B 25/003; B66B 25/006; B66B 5/0018; H04L 67/10

(57) ABSTRACT

Embodiments are directed to receiving, by a cloud server, data that is configured to control at least dispatching operations associated with a conveyance device, and distributing, by the cloud server, the data to a controller associated with the conveyance device. Embodiments are directed to an apparatus comprising: at least one processor, and memory having instructions stored thereon that, when executed by the at least one processor, cause the apparatus to: receive data that is configured to control at least dispatching operations associated with a conveyance device, and distribute the data to a controller associated with the conveyance device.

### BACKGROUND

In conventional elevator systems, controls (e.g., control software) are stored and operated locally on a control board at each instance or installation. Adding or modifying (e.g., upgrading) functionality requires service personnel to manually replace the software on the control board or download the software to a local unit via a connection (e.g., a remote connection). A software upgrade may require a corresponding hardware upgrade.

Functions and capabilities continue to be added to elevator controllers. Controller software might not be automatically upgraded unless manually executed at a user's request. Future functionality may someday reach the memory and computing power resource limitations in the existing control boards. At that point, a user may have to elect to forego incorporating additional functionality or otherwise incur large expenses upgrading a supporting platform (e.g., hardware).

### BRIEF SUMMARY

An embodiment of the disclosure is directed to a method comprising: receiving, by a cloud server, data that is configured to control at least dispatching operations associated with a conveyance device, and distributing, by the cloud server, the data to a controller associated with the conveyance device.

An embodiment of the disclosure is directed to an apparatus comprising: at least one processor, and memory having instructions stored thereon that, when executed by the at least one processor, cause the apparatus to: receive data that is configured to control at least dispatching operations associated with a conveyance device, and distribute the data to a controller associated with the conveyance device.

An embodiment of the disclosure is directed to a system comprising: a plurality of conveyance devices, at least one controller configured to control operations associated with the plurality of conveyance devices, and a cloud server configured to distribute, to the at least one controller, data that is configured to control at least dispatching operations associated with each of the plurality of conveyance devices.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more embodiments;

FIG. 2 illustrates an exemplary block diagram of inputs influencing elevator controls in accordance with one or more embodiments; and

FIG. 3 illustrates a flow chart of an exemplary method in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for maintaining, updating/modifying, and upgrading an elevator system. In some embodiments, functionality typically associated with an elevator controller may be located in another device or entity, such as a cloud server. The elevator controller may communicate with the cloud server to support selected control functions.

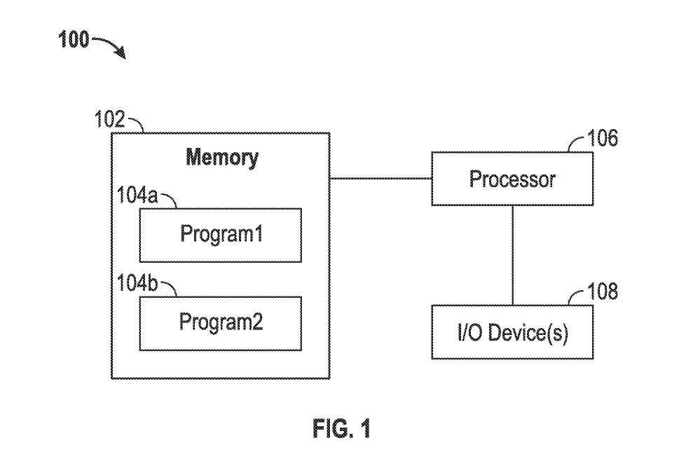

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, procedures, methods, functions, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

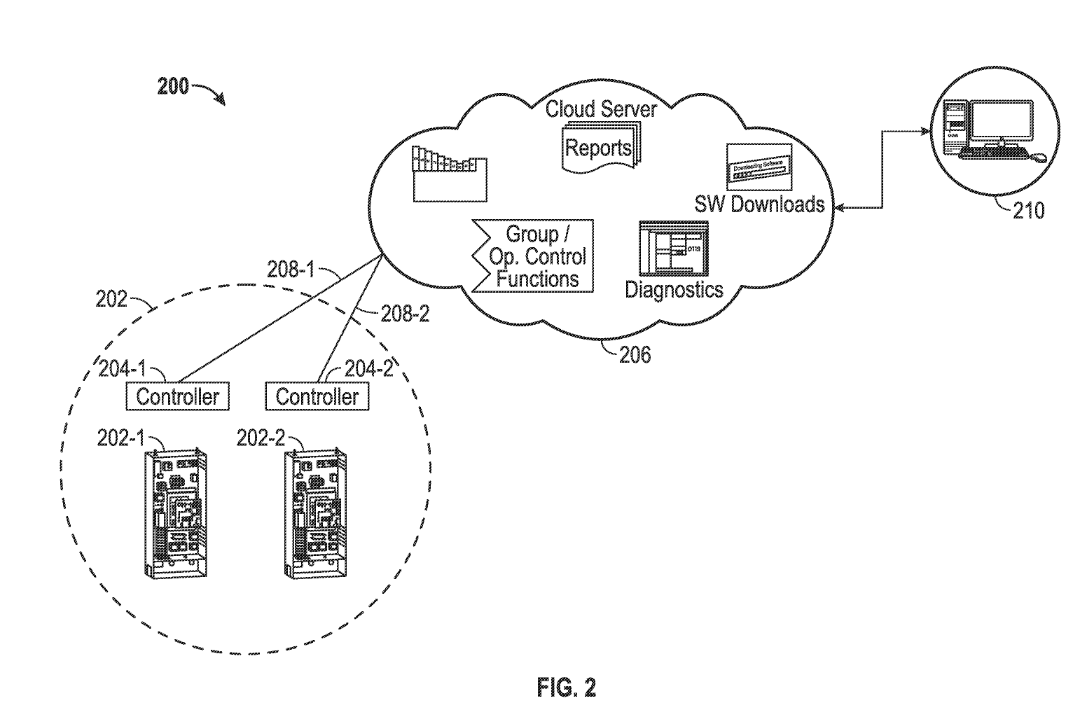

Turning now to FIG. 2, an exemplary system block diagram 200 in accordance with one or more embodiments is shown. As shown in FIG. 2, the system 200 may include one or more elevators, such as elevators 202-1 and 202-2. The elevators 202-1 and 202-2 may be included in an elevator group 202. For example, the elevator group 202 may include some or all of the elevators at a particular location, such as a building. While two elevators 202-1 and 202-2 are shown in FIG. 2, an elevator group 202 may include more or less than two elevators. In some embodiments a controller (e.g., controller 204-1) may be integrated in an elevator (e.g., elevator 202-1).

The elevator group 202 may include one or more controllers, such as controllers 204-1 and 204-2. The controller 204-1 may be associated with the elevator 202-1. The controller 204-2 may be associated with the elevator 202-2. In some embodiments, the controllers 204-1 and 204-2 may be combined, such that a common controller may be associated with each of the elevators 202-1 and 202-2.

In conventional systems, a controller may have been responsible for the operation of an elevator, such as elevators 202-1 and 202-2. In this respect, in conventional systems a controller includes all the hardware and software needed to implement functionality (e.g., control functionality) with respect to elevators that were overseen or regulated by the controller.

In accordance with one or more embodiments of this disclosure, selected controller functionality may be moved or relocated from a controller (e.g., controller 204-1 and/or controller 204-2) to another entity, such as a cloud server 206. By moving functionality to another entity, a reduction in hardware (e.g., circuitry) within the controller may be realized. In this respect, controller design may be simplified, which may result in a more reliable controller. Changes in functionality may also be made at one central location (e.g., at the cloud server 206), resulting in a consistent implementation across multiple controllers and/or elevator groups simultaneously and without requiring manual intervention at a local site (e.g., at the elevator group 202). In some embodiments, elevator groups may be remotely located from one another (e.g., in different buildings). Cloud 206 or controller 204-1 and/or 204-2 deployment decision criteria may be available to determine if-and-when new functions are made available to controllers 204-1 and 204-2.

The controller 204-1 and the controller 204-2 may communicate with the cloud server 206 over one or more connections, channels, or links. For example, the controller 204-1 may communicate with the cloud server 206 via a connection 208-1. The controller 204-2 may communicate with the cloud server 206 via a connection 208-2. The connections 208-1 and 208-2 may adhere to one or more communication protocols, standards, or the like. For example, the connections 208-1 and 208-2 may adhere to telephone, cellular, Wi-Fi, Ethernet, satellite, or cable communications. In some embodiments, the connections 208-1 and 208-2 may be constant or persistent.

As described above, functionality may be (re)located to a cloud server (e.g., cloud server 206). Such functionality may include dispatch functions for a group of elevators (e.g., elevator group 202), operational mode determinations, diagnostic functions, special contract features, etc. Regarding dispatch functions, in some embodiments a user request for service received at, e.g., a hall box located on a particular floor of a building may be communicated to the cloud server and the cloud server may transmit a command that directs a specified elevator car to relocate to that particular floor to fulfill the service request.

In some embodiments, a local controller (e.g., controller 204-1 and/or controller 204-2) may maintain some functionality, and as such, may include hardware and computing resources to support such functionality.

A controller may include hardware and/or software to communicate with a cloud server. For example, a controller may exchange data and commands with the cloud server to perform control functions. The cloud server may store contract setup parameters for select functions. In some embodiments, the contract setup parameters may be stored in the controller. In some embodiments, there may be a simplified failover functionality located in the controller in the event that there is a connection loss between the controller and the cloud server.

In some embodiments, operational metrics may be collected at a cloud server across a portfolio of multiple units, sites, or groups. The metrics may be analyzed by, e.g., a backend computer 210 to provide a broad view of the portfolio. For example, the analysis may indicate trends and may be used to respond to needs (e.g., product needs or functionality needs). The analysis may also be used to facilitate diagnostic or troubleshooting capabilities. Metrics may be used to trigger or enhance the accuracy of sales proposals. Metrics may be used to provide or schedule maintenance activities, such as preventative maintenance activities.

In some embodiments, interface protocols for, e.g., new devices may be stored in a cloud server and used by a local controller.

In some embodiments, functional upgrades for diagnostics, prognostics, and remote repair/rescue functions can be deployed to customers as they are released and deployed into a cloud server. Functionality may be developed at the backend computer 210 and deployed to the cloud server 206. One or more tests may be executed to ensure that the functionality satisfies operational or safety requirements.

In some embodiments, a modernization of cloud supported controllers may be provided. Controllers may utilize a cloud or cloud server to enable new features or support new devices/equipment. Before or during the modernization, the controller may receive updates via the cloud to support interface protocols to new equipment and/or add new functions/capabilities. For example, if a new fixture is added requiring a new interface, a controller may enable the new functionality from the cloud once the new fixture has been integrated into the system without requiring an upgrade of software on the controller. As yet another example, a new dispatching algorithm may be implemented from the cloud to optimize traffic during the modernization phase of the project.

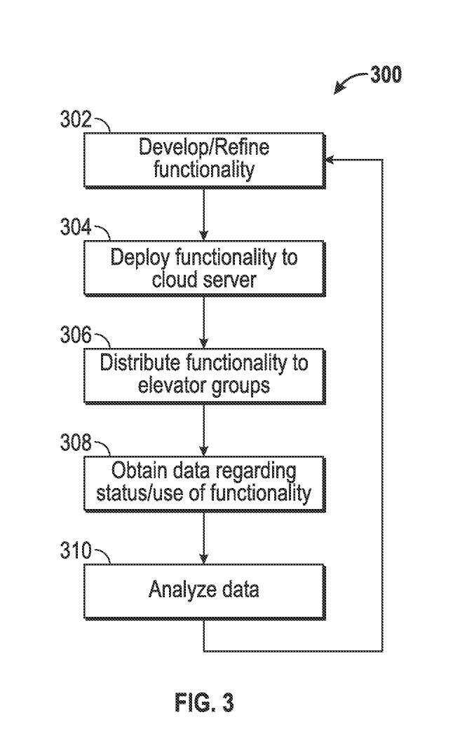

Turning now to FIG. 3, a method 300 is shown. The method 300 may be executed in connection with one or more systems, components, or devices, such as those described herein (e.g., the system 100, the controllers 204-1 and 204-2, the cloud server 206, the backend computer 210, etc.). The method 300 may be used to control or adjust the operation or functionality of an elevator.

In block 302, functionality may be developed. For example, a programmer, an engineer, or the like may develop a computer program to implement one or more operations, functions, or controls with respect to an elevator (e.g., elevator 202-1) or one or more groups of elevators (e.g., group 202). The development may take place in connection with one or more tools or devices, such as the backend computer 210. The functionality may take the form of data.

In block 304, the functionality developed in block 302 may be deployed to one or more entities, such as the cloud server 206.

In block 306, the functionality may be distributed from the cloud server 206 to one or more elevator groups, such as the elevator group 202. The distribution of the functionality may include a communication of data between the cloud server 206 and one or more elevator controllers (e.g., controllers 204-1 and 204-2).

In block 308, data regarding the status or use of the functionality in one or more elevators or elevator groups may be obtained. For example, upon receipt of the functionality in block 306, a controller may provide a status of whether the functionality was successfully implemented at one or more elevators in block 308. Data regarding the use of the functionality may be provided by the controller to, e.g., the cloud server 206 as part of block 308.

In block 310, the data of block 308 may be analyzed. The analysis may be performed by, e.g., the cloud server 206 and/or the backend computer 210. The analysis may be used for any number of reasons, such as those described above. For example, the analysis may be performed to identify any refinements that are needed to the functionality developed in block 302. Accordingly, the flow from block 310 to block 302 may cause a refinement of one or more functions developed in block 302, which may result in an increment of a version number associated with the functionality. In some instances, the analysis of the data in block 310 may trigger development of supplemental or additional functionality in connection with the flow from block 310 to block 302.

The method 300 is illustrative. In some embodiments, one or more blocks or operations (or a portion thereof) may be optional. In some embodiments, the blocks may execute in an order or sequence different from what is shown in FIG. 3. In some embodiments, additional blocks not shown may be included.

While some of the examples described herein related to elevators, aspects of this disclosure may be applied in connection with other types of conveyance devices, such as a dumbwaiter, an escalator, a moving sidewalk, a wheelchair lift, etc.

Embodiments of the disclosure may be used to reduce local controller hardware and/or software. For example, functionality may be at least partially supported by one or more servers, such as one or more cloud servers. Increased or upgraded functionality may be provided without impacting local controller memory or processing requirements/capacities.

Embodiments of the disclosure may have high-level control functionality implemented remote from an elevator. Functionality may be modified off-line. Functionality may be pushed from a cloud server to one or more elevators once the functionality is available. In some embodiments, an elevator may be configured to request functionality via, e.g., a pull-model.

Embodiments of the disclosure may be tied to one or more particular machines. For example, a controller may be configured to communicate with a cloud server. The cloud server may store data that may be used to control one or more functions associated with an environment or application. The data may be communicated from the cloud server to the controller to support operations within the environment or application.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
receiving, by a cloud server, data that is configured to control at least dispatching operations associated with a conveyance device; and
distributing, by the cloud server, the data to a controller associated with the conveyance device.

2. The method of claim 1, wherein the conveyance device comprises at least one of an elevator, a dumbwaiter, an escalator, a moving sidewalk, and a wheelchair lift.

3. The method of claim 1, wherein the cloud server receives the data from a backend computer.

4. The method of claim 1, wherein the conveyance device is included in a group of conveyance devices.

5. The method of claim 4, wherein the controller controls each of the conveyance devices in accordance with the data.

6. The method of claim 1, further comprising:
obtaining, by the cloud server, second data regarding a status of an implementation of the data from the controller.

7. The method of claim 1, further comprising:
obtaining, by the cloud server, second data regarding use of the data from the controller.

8. The method of claim 7, further comprising:
analyzing the second data to identify at least one of:
a product need associated with the conveyance device,
a needed diagnostic capability associated with the conveyance device,
a sales proposal associated with the conveyance device, and
maintenance needed with respect to the conveyance device.

9. The method of claim 1, wherein the data comprises at least one of:
an operational mode determination function,
a diagnostic function, and
a special contract feature function.

10. The method of claim 1, wherein the controller comprises hardware configured to provide for a failover functionality in the event that a connection between the controller and the cloud server is lost.

11. An apparatus comprising:
at least one processor; and
memory having instructions stored thereon that, when executed by the at least one processor, cause the apparatus to:
receive data that is configured to control at least dispatching operations associated with a conveyance device, and
distribute the data to a controller associated with the conveyance device.

12. The apparatus of claim 11, wherein the apparatus comprises a cloud server.

13. The apparatus of claim 11, wherein the conveyance device comprises an elevator.

14. The apparatus of claim 11, wherein the data is implemented as a software program, and wherein the apparatus receives the software program from a backend computer.

15. The apparatus of claim 11, wherein the apparatus is configured to distribute the data to the controller using at least one of: a telephone connection, a cellular communications connection, a Wi-Fi connection, an Ethernet connection, a satellite connection, and a cable communications connection.

16. The apparatus of claim 11, wherein the instructions, when executed by the at least one processor, cause the apparatus to:
obtain, from the controller, second data regarding use of the data.

17. A system comprising:
a plurality of conveyance devices;
at least one controller configured to control operations associated with the plurality of conveyance devices; and
a cloud server configured to distribute, to the at least one controller, data that is configured to control at least dispatching operations associated with each of the plurality of conveyance devices.

18. The system of claim 17, further comprising:
a second plurality of conveyance devices remotely located from the plurality of conveyance devices; and
a second at least one controller configured to control at least dispatching operations associated with the second plurality of conveyance devices.

19. The system of claim 18, wherein the cloud server is configured to distribute the data to the second at least one controller at substantially the same time that the cloud server distributes the data to the at least one controller.
